(19) United States
(12) Patent Application Publication
(10) Pub. No.: US 2020/0206073 A1
(43) Pub. Date: Jul. 2, 2020

(54) DEVICE FOR PROVIDING A SUBJECT WITH A SENSATION OF VIBRATION AND THE USE OF SUCH DEVICE AS MEDICAL DEVICE IN TREATMENT, PARTICULARLY FOR USE IN TREATMENT OF CANCER IN A SUBJECT

(71) Applicant: Sonus Health B.V., Heerde (NL)

(72) Inventor: Wijbren Ate Ritsma, Heerde (NL)

(21) Appl. No.: 16/646,969

(22) PCT Filed: Sep. 18, 2018
(86) PCT No.: PCT/NL2018/050614

§ 371 Date: Mar. 12, 2020

(30) Foreign Application Priority Data
Sep. 18, 2017 (EP) 17191698.4

(51) Int. Cl. A61H 23/02; A61H 1/00

(52) U.S. Cl. CPC A61H 23/0236; A61H 1/005; A61H 2201/0146; A61H 2201/0149; A61H 2201/5043; A61H 2201/1683; A61H 2201/5002; A61H 2201/5005; A61H 2201/105

(57) ABSTRACT

A device is described for providing a subject with a sensation of vibration in the subject's body. The device comprises a support member having a support surface for supporting at least a part of the body of the subject. The support member is provided with at least one sound transducer for generating and transmitting waves through the support surface to the subject's body. The support member comprises, between the at least one sound transducer and the support surface, a layer of material that absorbs physical vibrations while allowing sound waves to pass there through to the subject's body.

The invention relates to a device for providing a subject with a sensation of vibration in the subject's body, the device comprising a support member having a support surface for supporting at least a part of the body of the subject and the support member provided with means for generating and transmitting waves through the support surface to the subject's body.

The experience of vibrations felt in one's body has been shown to potentially provide beneficial effects in a subject or person. For instance the sensation of vibrations may cause a relaxation or excited state in the subject's body. Accordingly many devices have been developed that provide vibrations to the body of a subject. For instance well known are beds or chairs provided with vibrating elements, in which perceptible vibrations are transmitted by the vibrating elements to the body of a subject lying or sitting on a support surface of the bed or chair. The vibrating elements may provide mechanical vibrations, as in massage chairs or beds, which may be perceived by the subject as providing a relaxing or pleasing sensation. In many applications however, particularly therapeutic applications, such mechanical vibrations may prove to cause adverse effects in the subject. For instance a subject may experience motion sickness or increased stress when resting on a vibrating support surface.

Instead of mechanical vibrations from a moving or shaking support surface, a subject may also experience the sensation of vibrations in the subject's body from soundwaves transmitted to the body from soundwave generating means. Sound is since long considered to be useful in healing and therapy. The effect of soundwaves on the body has been widely investigated and is seen as a potential source of vibrational energy which may affect the body in many ways. Research has shown that each organ and system of the user's body has a specific, ideal frequency. Soundwave therapy is based on utilizing soundwaves that resonate with these frequencies of the organs and systems. Known examples of devices utilizing soundwaves are chairs or beds comprising one or more transducers or speakers for transmitting soundwaves to the person or subject lying or sitting on a support surface of the bed or chair. The transducers or speakers may be adapted or controlled to transmit soundwaves at resonant frequencies with the subject's organs and systems. Experiments with these known devices have demonstrated that soundwave therapy amongst others seems to have an effective role in reducing stress and anxiety, lowering blood pressure and improving general well being in a subject, and potentially could be used to treat many specific conditions and/or specific organs or systems in the user's body.

A drawback of the known devices is that the transducers or speakers mounted in the device when producing the required, mostly low frequency, soundwaves also in many instances generate physical vibrations in the housing of the speaker or transducer, which vibrations are transmitted through the support surface to the user's body. Accordingly the user may still experience these physical vibrations which could lead to adverse effects in the subject.

Accordingly, it is an object of the present invention to provide a device which aims to overcome this drawback.

To this end the invention provides a device as defined in one or more of the appended claims.

Particularly, according to the invention there is provided a device for providing a subject with a sensation of vibration in the subject's body, the device comprising a support member having a support surface for supporting at least a part of the body of the subject and the support member provided with means for generating and transmitting waves through the support surface to the subject's body, the device characterized in that the wave generating and transmitting means comprise at least one sound transducer capable of generating and transmitting soundwaves to the subject's body, and in that the support member between the at least one sound transducer and the support surface comprises a layer of material adapted for absorbing physical vibrations. By providing such a layer of material particularly between the at least one sound transducer and the support surface of the support member physical vibrations produced by said transducer will to a great extent be eliminated at the support surface. Accordingly, any sensation of physical vibrations by the user of the device will be reduced or non-existing and as such possible adverse effects in the user due to physical vibrations may be minimized. The layer of material between the at least one sound transducer and support surface may particularly be adapted to absorb any physical vibrations of the at least one sound transducer irrespective of an output by said transducer, e.g. frequency and amplitude or volume of the soundwaves emitted. As such any desired soundwave program, with consistent or alternating soundwave frequencies, amplitudes, volumes etcetera, can be employed without creating a vibrating, e.g. trembling, shaking or otherwise moving, support surface in the device. Accordingly the device of the present invention can be utilized for many applications, and in particular as a medical device for therapeutic treatments.

Any material with good vibration absorbing or dampening properties may be used for the layer. In addition to the sort of material, a thickness of the layer of material may be adapted for optimal vibration absorbing or dampening characteristics of the layer. In a preferred embodiment hereof the device according to the present invention is characterized in that the layer of material has a thickness between the sound transducer and the support surface adapted to minimize transmission of physical vibrations produced by the sound transducer to the support surface to a level below a minimal sensing level of the part of the subject's body supported on the support surface, while allowing soundwaves generated by the sound transducer to pass through the layer to the subject's body. The thickness of the layer may in a further preferred embodiment of the device according to the present invention vary between 10-300 mm, and may depend on the size and type of transducer as well as the sort of material used for the layer.

In a further preferred embodiment the device according to the present invention is characterized in that the material is a foam, particularly a foam rubber, more particularly a non-acoustic foam or foam with relatively low density or foam with relatively high open cell structure. Such materials can provide good vibration or shock absorbing or dampening properties, while allowing soundwaves to pass there through. Preferably the soundwaves passing through the layer are not absorbed or dampened by the material so that by controlling the at least one transducer desired characteristics of the soundwaves generated and transmitted thereby, e.g. frequency and amplitude, are at least substantially maintained when transmitted through the layer and the support surface to the body of the user. Preferably the material is selected so as to be suitable as filling of a support member such as a pillow, part of a chair or part of a bed or matrass. The material of the layer may be the same as the rest of the material used for the support member filling. Alternatively the support member may be mainly filed with one material, with the material of the layer being a different material.

A further preferred embodiment of the device according to the present invention is characterized in that the sound transducer is able and adapted to generate and transmit soundwaves in a low-frequency spectrum, particularly in a frequency range between 25-120 Hz. The low-frequency spectrum is particularly used in most soundwave therapies as these frequencies correspond to the resonating frequencies of most body parts, systems and organs. The device may generate and transmit soundwaves in the hearing spectrum and/or that can be heard by the subject, however it may in some instances and particular applications be preferred that the soundwaves generated and transmitted to the subject are not detectable by the user's auditory system, i.e. cannot be heard.

In a further preferred embodiment the device according to the present invention is characterized in that a plurality of transducers is provided in the support member for generating and transmitting sound waves to the user's body at respective locations of the support surface each location associated with one of the plurality of transducers. Accordingly soundwaves can be transmitted through the support surface at multiple locations of the device as desired by activating any or all of the plurality of transducers.

A particular embodiment of the device according to the present invention is characterized in that each of the plurality of transducers is controllable independently to enable independent generation and transmission of sound waves at each location of the support surface associated with one of the plurality of transducers. As such each transducer of the plurality of transducers may be controlled or adapted to generate and transmit soundwaves to a respective part of the users body supported on the associated location of the support surface, for example to enable treating such body parts independently from each other. For instance the transducers may be operated or controlled to generate and transmit soundwaves with different frequencies and/or amplitudes and/or to vary in starting time, intervals, periods etcetera. Each of the plurality of transducers may provide a soundwave program adapted to the part of the user's body supported on the associated support surface of the support member of the device. The transducers can also be grouped in several groups of transducers with each transducer within one group generating and transmitting identical soundwaves to the user's body. The groups may be associated with specific parts of the user's body, e. g. a first group of transducers associated with a head of the user, a second group of transducers associated with a torso of the user, and a third group of transducers associated with one or more limbs of the user. The plurality of transducers may also provide a single soundwave program with each of the plurality of transducers generating and transmitting identical soundwaves to the user's body.

A further particular embodiment of the device according to the present invention is characterized in that a thickness of the layer of material adapted for absorbing physical vibrations while allowing the sound waves to pass there through to the subject's body for each of the plurality of transducer is adapted in dependence on the respective location of each of the plurality of transducers. Particularly a thickness of the layer may differ in dependence of the level of pressure exerted by body parts of the user when supported on the support surface of the support member. For example a body of a user lying on a support member such as for instance a pillow or mattress of a chair, couch or bed will exert different loads on the support surface with different parts of the body in dependence of the positioning and orientation of the body on the support surface. Particularly the head, shoulders, elbows, buttocks and/or feet of the user may provide a relatively high load on the support surface as compared to other parts of the body. As such the respective parts of the support member associated with these higher load providing body parts may comprise a thicker layer of material. between the transducer provided in that part and the support surface as compared to parts of the support member associated with lower load providing body parts. Alternatively or additionally for each layer associated with one of the plurality of transducers the material it is formed of may be adapted to the particular positioning of the associated transducer with respect to the support surface. For instance the layers positioned in a part of the support member associated with the higher load providing body parts may comprise a different material as compared to the layers positioned in other parts of the support member associated with lower load providing body parts. This to compensate for a difference in compaction of the layers due to the different loads acting thereupon in order to maintain a same soundwave profile of soundwaves transmitted through each of the layers to the users body. Important is that the device enables an optimized control and accuracy of soundwaves being transmitted to the user's body parts so as to be able to provide and maintain a resonance frequency of the soundwaves to each body part, e.g. organ or system, of the user.

In another preferred embodiment the device according to the present invention is characterized in that the support member is a pillow. The pillow may be a pillow for supporting a complete body of a user such as a pillow for lying thereon, e.g. a mattress, or may be for supporting a part of a body of a user such as a head pillow for resting a head thereon. In particular the device may be a piece of furniture for supporting at least a part of a body of a subject on a support surface thereof, such as a chair or bed.

A further particular embodiment of the device according to the present invention is characterized in that the support member is carried on a rigid frame, wherein the at least one sound transducer provided in the support member is separated from the frame by a layer of material adapted for absorbing physical vibrations of the at least one sound transducer. By providing the sound transducer separately from any rigid part in the device any vibrations produced by the transducer in use will be absorbed by the surrounding layer of material and not be transmitted via the rigid parts to the support surface.

In a further particular embodiment the device according to the present invention is characterized in that the at least one sound transducer is enclosed in all directions by the material adapted for absorbing physical vibrations of the at least one sound transducer. The at least one transducer may for instance be provided in a space between several layers of material filling the support member or be provided in a cavity provided in one integral body of material.

In a further preferred embodiment the device according to the present invention is characterized in that the device is a chair, bed or other type of furniture for supporting at least a part of a body of a subject.

The device of the present invention may be part of a system in which the at least one transducer in the device is controlled via separate means to generate and transmit desired soundwaves. A further particular embodiment of the device according to the present invention is however characterized in that the device comprises control means adapted for controlling a soundwave output of the at least one transducer provided in the support member. Thus the control means are part of the device, which accordingly can be used as a stand alone unit, for instance a complete medical device such as a therapeutic chair or bed, without the need of additional separate means.

In a further particular embodiment the device according to the present invention is characterized in that the device comprises one or more of a processor, a data memory, a power source, a communication unit, and an interface, particularly a display. The device may be programmed to provide desired soundwave therapy programs to a user. For instance data relating to specific soundwave programs may be stored in a data memory in the device and processed by a processor to activate the one or more transducers in the device in accordance with the respective desired program. The data relating to soundwave programs may comprise data with respect to specific treatments of particular conditions and/or particular parts of the body parts as well as data relating to the specific user, e.g. patient data. A communication unit may be provided in the device to enable communication of data between the device and a network, e.g. an intranet, such as used in a medical facility, or the internet, for instance to enable automatic or non-automatic updating of software in the device, such as the soundwave program data. The interface or display may be provided as a means for providing input in the device by a user or other person and/or for providing output, such as information relating to any active soundwave program, to the user or any other person.

The device according to the present invention has many suitable applications, and may for instance be used as furniture, e.g. a bed or chair, on which a user may rest by sitting or lying on the support surface. The device may be adjustable and/or have an adjustable support surface for adapting the support surface to for instance a comfortable support position with respect to the user's body. The present invention particularly relates to a device according to the present invention for use as a medical device. Specifically the device according to the present invention is a class IIA medical device. More specifically the device according to the present invention is a class IIA certified therapeutic chair. The therapeutic chair according to the present invention may be for exclusive use in medical environments or facilities such as in a health care centers, hospitals, (private) clinics etcetera.

In particular the device according to the present invention is for use in a chemotherapy, wherein the device supports a subject, e.g. a human patient, undergoing treatment with chemotherapy, and wherein the device is controlled to provide with the at least one transducer a soundwave therapy to the subject during the treatment. The soundwave therapy provided by the device may be particularly directed at transmitting soundwaves which stimulate peripheral nerves of the subject in order to prevent chemotherapy induced peripheral neuropathy.

The device according to the present invention is particularly for use in treatment of cancer in a subject by chemotherapy, wherein the device supports the subject undergoing treatment with chemotherapy, and wherein the device is controlled to provide with the at least one transducer a soundwave therapy to the subject during the treatment. The soundwave therapy provided by the device may be particularly directed at transmitting soundwaves which stimulate peripheral nerves of the subject in order to prevent chemotherapy induced peripheral neuropathy.

In a preferred aspect of the device for use according to the invention the at least one transducer is adapted to provide a soundwave therapy to the subject comprising transmitting low-frequency soundwaves in a range between 25-120 Hz to at least part of the subject's body.

In a further preferred aspect of the device according to the invention the at least one transducer is adapted to transmit soundwaves which affect a nervous system of the subject's body, and is particularly adapted to transmit soundwaves which stimulate peripheral nerves of the subject. This may prevent or at least reduce chemotherapy induced peripheral neuropathy in the subject treated.

The present invention also relates to a method of treating cancer in a subject, comprising giving chemotherapy to the subject, particularly by administering chemotherapeutic agents to the subject, wherein the subject is treated with a soundwave therapy in which soundwaves are transmitted to the subject's body which affect a nervous system of the subject's body, and particularly stimulate peripheral nerves of the subject. Preferably the method involves treating the subject with the soundwave therapy during at least part of the chemotherapy. For example the subject may be supported on a device according to the invention while chemotherapeutic agents in the chemotherapy are administered to the subject. The method according to the invention improves cancer treatments with chemotherapy, in that the soundwave treatment prevents or at least reduces neuropathies experienced by the subject (patient), particularly neuropathies as a result of the chemo treatment. In particular a possible interruption or premature stop of the chemotherapy program due to severe neuropathy may accordingly be prevented with the method of the invention.

The present invention particularly relates to a method of treating cancer in a subject, comprising giving chemotherapy to the subject, particularly by administering chemotherapeutic agents to the subject, while the subject is supported on a device according to the invention, wherein during at least part of the chemotherapy the at least one transducer in the device provides a soundwave therapy to the subject in which soundwaves are transmitted to the subject's body which affect a nervous system of the subject's body, and particularly stimulate peripheral nerves of the subject.

In a preferred embodiment of the method according to the invention the soundwaves transmitted by the at least one transducer are adapted to prevent chemotherapy induced peripheral neuropathy.

The present invention is not limited to the above referred embodiments and aspects.

For the purpose of clarity and a concise description features are described herein as part of the same or separate embodiments, however, it will be appreciated that the scope of the invention may include embodiments having combinations of all or some of the features described throughout the application. It will be clear to the skilled person that the invention is not limited to any embodiment herein described and that modifications are possible which may be considered within the scope of the appended claims. Additions, deletions, and modifications within the purview of the skilled person may generally be made without departing from the scope of the invention, as determined by the claims.

### EXPERIMENT

In a Deep Sound Wave Therapy (“DSWT”) Trial, which was approved by The Medical Center of Central Georgia Institutional Review Board (“IRB”) on Apr. 14, 2016, patients commencing new treatment with neuro-toxic chemotherapy were the subject of treatment with a Deep Sound Wave Therapy Chair (“Chair”) between chemotherapy visits. The trial design was altered in January 2017 to allow enrollment by those who may have already received a dose of chemotherapy. This protocol was approved Jan. 19, 2017.

The trial is nearing the accrual goal of 25 subjects. All subjects are women. The range in age is from 34 years old to 82 years old with an average age of 63 years, 9 months and 15 days. Almost all subjects were scheduled to receive Carboplatin and Taxol for their chemotherapy.

The trial therapy has been well tolerated and few issues during the DSWT have occurred. There have been 2 early withdrawals from therapy due to pre-existing conditions.

The DSWT program increased intensity and duration of the treatment as the therapy progresses with subjects during early treatments receiving approximately 3×30 mins cycles and intermittent rest times, total treatment time of about 3 hours. Later treatments approach 5-6 hours' duration. Subjects were asked to report problems as they develop, with nursing staff able to reduce intensity or suspend the program. There have been few interrupted treatments, most interruptions have been for bathroom breaks and no treatments have been adjusted for intensity. Most subjects have advanced to longer duration treatments.

Prior to each treatment, a neuropathy questionnaire was completed. Thirteen statements are ranked on a scale from ‘Not at all’ to ‘Very Much’. Maximum possible score is 52, minimum is 0. The highest recorded score was 44 and this was recorded prior to any chemotherapy or DSWT. This subject opted out of treatments after the first round because her preexisting conditions prevented her from completing therapy treatment. A second subject was removed from therapy for several rounds of treatments due to unforeseen events. This subject has since resumed therapy. Apart from these two notable exceptions every subject has received therapy with treatments as planned. Treatments have been well tolerated. There have been no delays in treatments reported due to peripheral neuropathy. This may demonstrate a positive correlation of DSWT during chemotherapy in protecting against Chemotherapy Induced Peripheral Neuropathy.

1. A device for providing a subject with a sensation of vibration in the subject's body, comprising:
a support member having a support surface for supporting at least a part of the body of the subject, the support member provided with vibration source configured to generate and transmit waves through the support surface to the subject's body,
wherein the vibration source comprises at least one sound transducer capable of generating and transmitting sound waves to the subject's body, and
wherein the support member between the at least one sound transducer and the support surface comprises a layer of material adapted for absorbing physical vibrations while allowing the sound waves to pass there through to the subject's body.

2. The device according to claim 1, wherein the layer of material has a thickness between the sound transducer and the support surface adapted to minimize transmission of physical vibrations produced by the sound transducer to the support surface to a level below a minimal sensing level of the part of the subject's body supported on the support surface.

3. The device according to claim 1, wherein the material is a foam.

4. The device according to claim 1, wherein the sound transducer is able and adapted to generate and transmit soundwaves in a low-frequency spectrum.

5. The device according to claim 1, wherein a plurality of transducers is provided in the support member for generating and transmitting sound waves to the user's body at respective locations of the support surface each associated with one of the plurality of transducers.

6. The device according to claim 5, wherein each of the plurality of transducers is controllable independently to enable independent generation and transmission of sound waves at each location of the support surface associated with one of the plurality of transducers.

7. The device according to claim 5, wherein a thickness of the layer of material adapted for absorbing physical vibrations while allowing the sound waves to pass there through to the subject's body for each of the plurality of transducer is adapted in dependence on the respective location of each of the plurality of transducers.

8. The device according to claim 1, wherein the support member is a pillow.

9. The device according to claim 8, wherein the support member is carried on a rigid frame, wherein the at least one sound transducer provided in the support member is separated from the frame by a layer of material adapted for absorbing physical vibrations of the at least one sound transducer.

10. The device according to claim 9, wherein the at least one sound transducer is enclosed in all directions by the material adapted for absorbing physical vibrations of the at least one sound transducer.

11. The device according to claim 1, wherein the device is a piece of furniture taken from the group consisting of: a chair, bed and any other type of furniture for supporting at least a part of a body of a subject.

12. The device according to claim 11, wherein the device comprises a controller configured to control a soundwave output of the at least one transducer provided in the support member.

13. The device according to claim 12, wherein the device comprises one or more of a processor, a data memory, a power source, a communication unit, an interface, and a display.

14. The device according to claim 1, wherein the device is used as a medical device.

15. The device according to claim 14, wherein the device is for use in a chemotherapy, wherein the device supports a subject undergoing treatment with chemotherapy, and wherein the device is controlled to provide with the at least one transducer a soundwave therapy to the subject during the treatment.

16. The device according to claim 14, wherein the device is for use in treatment of cancer in a subject by chemotherapy, wherein the device supports the subject undergoing treatment with chemotherapy, and wherein the device is controlled to provide with the at least one transducer a soundwave therapy to the subject during the treatment.

17. The device according to claim 15, wherein the at least one transducer is adapted to provide a soundwave therapy to the subject comprising transmitting low-frequency soundwaves in a range between 25-120 Hz to at least part of the subject's body.

18. The device for use according to claim 17, wherein the at least one transducer is adapted to transmit soundwaves which affect a nervous system of the subject's body, and is particularly adapted to transmit soundwaves which stimulate peripheral nerves of the subject.

19. A method of treating cancer in a subject, comprising giving chemotherapy to the subject, particularly by administering chemotherapeutic agents to the subject, wherein the subject is treated with a soundwave therapy in which soundwaves are transmitted to the subject's body which affect a nervous system of the subject's body, and particularly stimulate peripheral nerves of the subject.

20. A method of treating cancer in a subject, comprising giving chemotherapy to the subject, particularly by administering chemotherapeutic agents to the subject, while the subject is supported on a device comprising:
a support member having a support surface for supporting at least a part of the body of the subject, the support member provided with a vibration source configured to generate and transmit waves through the support surface to the subject's body;
wherein the vibration source comprises at least one sound transducer capable of generating and transmitting sound waves to the subject's body, and
wherein the support member between the at least one sound transducer and the support surface comprises a layer of material adapted for absorbing physical vibrations while allowing the sound waves to pass there through to the subject's body, and
wherein during at least part of the chemotherapy the at least one transducer in the device provides a soundwave therapy to the subject in which soundwaves are transmitted to the subject's body which affect a nervous system of the subject's body, and particularly stimulate peripheral nerves of the subject.

21. The method according to claim 20, wherein the soundwaves transmitted by the at least one transducer are adapted to prevent chemotherapy induced peripheral neuropathy.
